(19) United States
(12) Patent Application Publication
(10) Pub. No.: US 2025/0171580 A1
(43) Pub. Date: May 29, 2025

(54) POLYURETHANE SEALING MATERIAL AND A PREPARATION METHOD AND AN APPLICATION THEREOF

(71) Applicant: Jiangsu Changneng Energy-saving New Materials Science & Technology Co., LTD., Jiangsu (CN)

(72) Inventors: Kui Wu, Jiangsu (CN); Shuaishuai Chen, Jiangsu (CN); Dejie Ni, Jiangsu (CN); Huaiyi Chen, Jiangsu (CN)

(73) Assignee: Jiangsu Changneng Energy-saving New Materials Science & Technology Co., LTD., Jiangsu (CN)

(21) Appl. No.: 18/822,312

(22) Filed: Sep. 2, 2024

(30) Foreign Application Priority Data
Nov. 29, 2023 (CN) 202311607642.3
Nov. 29, 2023 (CN) 202311607758.7

(51) Int. Cl. C08G 18/48; C08G 18/20; C08G 18/32; C08G 18/65; C08G 101/00; C08K 3/04; C08K 3/26; C08K 3/30

(52) U.S. Cl. CPC C08G 18/485; C08G 18/2063; C08G 18/3203; C08G 18/6511; C08K 3/04; C08G 2101/00; C08G 2110/0066; C08G 2110/0083; C08G 2120/00; C08G 2190/00; C08K 2003/265; C08K 2003/3045

(57) ABSTRACT

Disclosed are polyurethane sealing material and a preparation method and an application thereof, to solve the technical problems in the prior art that the polyurethane seal material suffers from poor aging resistance and inadequate compression deformation properties. By adding the polyether carbonate polyol in the formulations, the polyurethane sealing material prepared in the present disclosure has better elongation at break, tensile strength, and tear strength after aging than those under normal conditions, and has lower permanent compression set; and no crosslinking agent is added in the present disclosure, such that the material can be prevented from losing elasticity at a lower temperature, and improved process operability and appearance can be obtained. The polyurethane sealing material prepared in the present disclosure can be applied in air filter sealing rings.

### CROSS-REFERENCE TO RELATED APPLICATION

This application claims the priority benefit of China application serial no. 202311607642.3, filed on Nov. 29, 2023, and China application serial no. 202311607758.7, filed on Nov. 29, 2023. The entirety of each of the above-mentioned patent applications is hereby incorporated by reference herein and made a part of this specification.

### TECHNICAL FIELD

The present disclosure relates to polyurethane sealing material and a preparation method and an application thereof.

### BACKGROUND

Polyurethane elastomer is a type of polymer material that contains a large amount of carbamate groups in its main chain, and is a block copolymer with alternating hard segments and soft segments formed by the reaction of isocyanate with polyol (polyether, polyester). Polyurethane elastomer is a type of material that lies between rubber and plastic, with a wide variety of raw materials, diverse formulations, and a broad range of adjustable properties.

As sealing material, such as polyurethane sealants, and polyurethane sealing gaskets (polyurethane sealing rings), polyurethane has a wide range of applications. Characterized by resistance to wear, oil, acid and alkali, ozone, aging, low temperature, tearing, impact, and the like, the polyurethane sealing rings have great load-bearing capacity and are widely used in various fields, including household appliances, where common household vacuum cleaners utilize sealing rings.

However, the existing polyurethane sealing materials (polyurethane sealing gaskets/polyurethane sealing rings) have the following problems: sealing products made of polyether polyurethane material alone exhibit poor resistance to media and aging, as well as poor wear resistance and permanent compression set.

Filter elements are one of the indispensable “three filters” for internal combustion engines, such as automobiles, ships, construction machinery, and generator sets. With the rapid development of the automobile industry in China, especially the development of the car industry, demands for filter elements have been increasing. Compared with traditional filter elements, polyurethane filter elements feature light weight, easy to process, high production efficiency, and low energy consumption. At present, the automobile industry worldwide has extensively employed the polyurethane elastomers as materials of the filter elements.

However, the market has raised higher requirements for the service life and aging resistance of the filter elements, this is mainly because: firstly, advancements in the automobile technology and the rising consumer expectations demand for better air quality in the cabin. Traditional filter elements suffer relatively significant compression deformation through a long period of compression, resulting in worse sealing effects; and secondly, as an engine compartment temperature rises during long-distance driving or in extreme conditions, the service life of traditional polyurethane sealing rings will be shortened due to aging and fragmentation of seal strips caused by high temperature, requiring frequent replacement of air filter elements, thereby increasing the maintenance costs. Therefore, many original equipment manufacturers have set higher standards for the filter elements. Therefore, it is very necessary to develop a polyurethane air filter element with excellent aging resistance, high mechanical strength, and low permanent compression set.

The Chinese Patent CN105111395A discloses a preparation method of an automobile polyurethane air filter element, including the following steps: reacting 70-90 parts by mass of polyether polyol, 10-40 parts by mass of polyester polyol, 1-4 parts by mass of diethylene glycol, 2-6 parts by mass of triethanolamine, 2-8 parts by mass of black polyether pulp, and 1-10 parts by mass of triethylene diamine at 40° C.-80° C. for 2-4 h to obtain liquid A; reacting the same at 60° C.-100° C. for 4-8 h to obtain liquid B; starting a machine to inject glue, where a mass ratio of the liquid A to the liquid B is 100:15-30; inserting a filter paper core after the glue is injected, demolding after 6-8 min to obtain the automobile polyurethane air filter element. The preparation method of the automobile polyurethane air filter element in the patent is simple and easy to carry out. The prepared liquid B does not crystallize even at −40° C., overcoming the cumbersome heating and dissolving steps in the preparation process. The resulting automobile polyurethane air filter element has good flexibility and mechanical strength. However, the patent fails to provide the data of service life and aging of the product.

### SUMMARY

A first technical problem to be solved by the present disclosure is to provide novel polyurethane sealing material with excellent aging resistance, improved compression deformation property (good permanent compression set), and strong mechanical properties, so as to solve the technical problems in the prior art that the polyurethane seal material suffers from poor aging resistance and inadequate compression deformation properties (poor compression set). A second technical problem to be solved by the present disclosure is to a preparation method of the polyurethane sealing material corresponding to the first technical problem to be solved. A third technical problem to be solved by the present disclosure is to provide an application of the polyurethane sealing material corresponding to the first technical problem to be solved.

In order to solve the foregoing first technical problem, the present disclosure provides the following technical solution: polyurethane sealing material, composed of Component A and Component B, where a ratio in parts by weight of Component A to Component B is 100:20-40. Specifically, Component A is composed of the following components in parts by weight: 70-90 parts of polyether polyol, 5-10 parts of polymer polyol, 5-10 parts of polyether carbonate polyol, 2-6 parts of a chain extender, 0.5-1.2 parts of a surfactant, 0.4-1 part of a catalyst, 0.2-1 part of a foaming agent, and 0-4 parts of a filler; where the polyether polyol is a polyether polyol copolymerized with ethylene oxide and propylene oxide, and terminated with ethylene oxide, with at least one of glycerol or trimethylolpropane as an initiator, and has a hydroxyl value of 25-30 mgKOH/g and a viscosity of 800-1500 mPa·s at 25° C.; the polymer polyol has a functionality of 3, a hydroxyl value of 19-23 mgKOH/g, and a solid content of 41-45%; the polyether carbonate polyol has a functionality of 2-3, a molecular weight of 2000-4000, and a mass percentage of CO₂ of 10-20%; the chain extender is selected from at least one of alcohol compounds or alcohol amine compounds with a functionality of 2; the catalyst is a tertiary amine catalyst; the surfactant is a polysiloxane-olefin oxide block copolymer; and Component B is modified MDI.

In the above technical solution, preferably, the chain extender is selected from at least one of ethylene glycol, diethylene glycol or 1,4-butanediol.

In the above technical solution, preferably, the surfactant is selected from at least one of B8745, B8734, B8742, B8738, S6109, S6308, L-3627 or L-3628.

In the above technical solution, preferably, the catalyst is selected from at least one of DPA, Z130, NE1050, 33LV or B8154; the foaming agent is water; and the filler is color paste.

In the above technical solution, preferably, the modified MDI is selected from at least one of Wannat-100LL, Cosmonate LL, Lupranate81/MM103/218/219 or Suprasec2020.

In order to solve the foregoing first technical problem, the present disclosure provides another technical solution: polyurethane sealing material, composed of Component A and

Component B, where a ratio in parts by weight of Component A to Component B is 100:20-40. Specifically, Component A is composed of the following components in parts by weight: 50-70 parts of polyether polyol, 5-10 parts of polyether carbonate polyol; 2-6 parts of a chain extender, 0.5-1.2 parts of a surfactant, 0.7-1.5 parts of a catalyst I, 0.1-0.3 part of a catalyst II, 0.2-1 part of a foaming agent, 0-1 part of an anti-aging agent, and 10-40 parts of a solid filler; where polyether polyol has a functionality of 2-4 and a hydroxyl value of 25-30 mgKOH/g, the polyether carbonate polyol has a functionality of 3, a hydroxyl value of 19-23 mgKOH/g, and a solid content of 41-45%; the chain extender is selected from at least one of alcohol compounds or alcohol amine compounds with a functionality of 2; the catalyst I and the catalyst II are tertiary amine catalysts; the surfactant is a polysiloxane-olefin oxide block copolymer; and Component B is modified MDI.

In the above technical solution, preferably, the chain extender is selected from at least one of ethylene glycol, diethylene glycol or 1,4-butanediol.

In the above technical solution, preferably, the surfactant is selected from at least one of B8745, B8734, B8742, B8738, S6109, S6308, L-3627 or L-3628.

In the above technical solution, preferably, the catalyst I is selected from at least one of DPA, Z130, NE1050, 33LV or B8154; and the catalyst II is selected from at least one of ZF10, A-1, NE300, LED103 or DMEA.

In the above technical solution, preferably, the foaming agent is selected from water; and the anti-aging agent is selected from BA316.

In the above technical solution, preferably, the solid filler is selected from one or a mixture of white carbon black, calcium carbonate, fly ash, lignin, titanium dioxide, talc, and barium sulfate.

In the above technical solution, preferably, the modified MDI is selected from at least one of Wannat-100LL, Cosmonate LL, Lupranate81/MM103/218/219 or Suprasec2020.

Hardness of the polyurethane sealing material is increased by adding the solid filler in the formulation, thereby reducing the costs while meeting the use requirements.

In order to solve the foregoing second technical problem, the present disclosure adopts the following technical solution:
a preparation method of the polyurethane sealing material, including the following steps:
(1) preparation of Component A: the following materials are weighed in parts by weight, 70-80 parts of the polyether polyol, 5-10 parts of the polymer polyol, 5-10 parts of the polyether carbonate polyol, 2-6 parts of the chain extender, 0.5-1.2 parts of the surfactant, 0.4-1 part of the catalyst, 0.2-1 part of the foaming agent, 0-4 parts of the filler are added in sequence in a container A; and the materials are stirred evenly at a temperature of 20-25° C. to obtain Material I; or
preparation of Component A: the following materials are weighed in parts by weight, 50-70 parts of the polyether polyol, 5-10 parts of the polyether carbonate polyol; 2-6 parts of the chain extender, 0.5-1.2 parts of the surfactant, 0.7-1.5 parts of the catalyst I, 0.1-0.3 part of the catalyst II, 0.2-1 part of the foaming agent, 0-1 part of the anti-aging agent, and 10-40 parts of the solid filler are added in sequence in a container A; and the materials are stirred evenly at a temperature of 20-25° C. to obtain Material I;
(2) preparation of Component B: the modified MDI is added into a container B, and stored at a temperature of 20-25° C. for later use, and Material II is obtained;
(3) Material I and Material II are pumped into Material Tank A and Material Tank B, respectively, and high-pressure circulation of Material Tank A and Material Tank B is started, respectively; a weight ratio of Material I to Material II is set at 100:20-40 on a high-pressure foaming machine, Material I and Material II are mixed and stirred in the high-pressure foaming machine at a high speed, and then rapidly injected into a pre-prepared closed mold, and a temperature of the closed mold is set at 50-65° C.; and after the injection is complete, the mold is closed and cured for 2-3 min, then the mold is opened to obtain the polyurethane sealing material product.

In order to solve the above technical problems, the present disclosure adopts the following technical solution:
an application of the foregoing polyurethane sealing material in air filter sealing rings, where the air filter sealing rings comprises automobile air filter sealing rings and household air filter sealing rings.

Beneficial effects: compared with the prior art, the present disclosure has the following significant advantages: in the prior art, polyester polyol is added to increase physical strength of a product, but the polyester polyol is prone to hydrolysis; and in the present disclosure, the polymer polyol is add to the system to adjust the initial mechanical strength of the polyurethane sealing material, and the polyether carbonate polyol is also added to enhance the strength of the material through the carbonate bonds contained in this structure. In the present disclosure, no crosslinking agent is added, such that the material can be prevented from losing elasticity at a lower temperature, and improved process operability and appearance can be obtained. In the present disclosure, the polyether polyol and the polymer polyol are added in the formulation system, and the polyether carbonate polyol is added for synergistic effects, and the polyurethane sealing material with relatively low permanent deformation data is successfully prepared. Surprisingly, an aging resistance test of the material shows that the elongation at break, tensile strength, and tear strength of the material are improved rather than worsen. After 168 h of aging testing, the material still exhibits good elongation at break, tensile strength, and tear strength.

### DETAILED DESCRIPTIONS OF THE EMBODIMENTS

The present disclosure will be described in detail below with reference to embodiments, but not limited to the embodiments herein.

TABLE 1
List of Raw Materials

| Category of | Name of raw | | |
|---|---|---|---|
| raw material | material | Manufacturer | Remark |
| Polyether | CHE-2801L | ChangHua Chemical | |
| polyol | | Technology Co., Ltd. | |
| | 10LD83EK | Shandong Bluestar | |
| | | Dongda Co., Ltd. | |
| | KE810L | KPX Chemical | |
| Polymer | CHP-H45 | ChangHua Chemical | |
| polyol | | Technology Co., Ltd. | |
| | P40 | Shandong Bluestar | |
| | | Dongda Co., Ltd. | |
| Polyether carbonate polyol I | | Self-made | |
| Polyether carbonate polyol II | | Self-made | |
| Chain | Ethylene glycol | Shandong Datang Precise | — |
| extender | | Chemical Industry | |
| | Diethylene glycol | SINOPEC Tianjin | — |
| | 1,4-butanediol | Xinjiang Markor Chem | — |
| Surfactant | B8745 | Evonik Industries | — |
| | B8734 | Evonik Industries | — |
| | B8742 | Evonik Industries | — |
| | B8738 | Evonik Industries | — |
| Catalyst | DPA | Huntsman | — |
| | Z130 | Huntsman | — |
| | NE1050 | Evonik | — |
| Catalyst I | DPA | Huntsman | — |
| | Z130 | Huntsman | — |
| Catalyst II | ZF10 | Huntsman | — |
| | A-1 | Evonik Industries | — |
| | NE300 | Evonik Industries | — |
| | LED103 | Huntsman | — |
| | DMEA | Huntsman | — |
| Filler | Color paste | Bomex | — |
| Solid filler | Calcium carbonate | Guangyuan Group | — |
| | Barium sulfate | Guizhou | — |
| | | Redstar Developing | |
| | White carbon | Longxing | — |
| | black | Chemical Stock | |
| Anti-aging | BA316 | Evonik Industries | — |
| agent | | | |
| Modified MDI | Wannat-100LL | Wanhua Chemical | — |
| | Cosmonate LL | KUMHO | — |
| | | MITSUI CHEMICALS | |
| | Suprasec2020 | Huntsman | — |

Polyether carbonate polyol I and polyether carbonate polyol II are prepared according to the method provided in the patent with publication number CN 105531299 A.

The testing standards or methods used for the polyurethane sealing material in the present disclosure are as follows:
Density testing standard: GB/T 6343-2009
Elongation at break testing standard: GB/T 6344-2008
Tensile strength testing standard: GB/T 6344-2008
Permanent compression set testing standard: GB/T 6669-2008 (Method A)
Tear strength testing standard: GB/T 10808-2006
Aging condition: 120 degrees 168H and 500H

### Example 1

A preparation method of the polyurethane sealing material, including the following steps:
(1) Preparation of Component A: the following materials were weighed in parts by weight, 79.8 parts of the polyether polyol (CHE-2801L), 5 parts of the polymer polyol (CHP-H45), 10 parts of the polyether carbonate polyol I, 3 parts of the chain extender (ethylene glycol), 0.5 part of the surfactant (B8734), 0.2 part of the catalyst I (DPA), 0.5 part of the catalyst II (Z130), 0.4 part of the foaming agent, and 0.6 part of the color paste were added in sequence in a container A; and the foregoing raw materials were stirred evenly at a temperature of 20-25° C. to obtain Material I.
(2) Preparation of Component B: 35 parts of the modified MDI (Wannat-100LL) was added into a container B, and stored at a temperature of 20-25° C. for later use, and Material II was obtained.
(3) Material I and Material II were pumped into Material Tank A and Material Tank B, respectively, and high-pressure circulation of Material Tank A and Material Tank B was started, respectively; a weight ratio of Material I to Material II was set to 100:35 on a high-pressure foaming machine, Material I and Material II were mixed and stirred in the high-pressure foaming machine at a high speed, and then rapidly injected into a pre-prepared closed mold, and a temperature of the closed mold was set at 50-65° C.; and after the injection was complete, the mold was closed and cured for 3 min, then the mold was opened to obtain the polyurethane sealing material product.

### Examples 2-6 and Comparative Example 1

Examples 2-6 and Comparative Example 1 were performed according to the steps in Example 1, except that reaction raw materials and raw material ratios in forming formulations were different, as shown in Table 2; and performance test data of the prepared polyurethane sealing materials were shown in Table 3.

TABLE 2
Parts of each component by weight in formulations of polyurethane
sealing materials in Examples 1-6 and Comparative Example 1

| | | | | | | | | Comparative |
|---|---|---|---|---|---|---|---|---|
| Component name | | Example 1 | Example 2 | Example 3 | Example 4 | Example 5 | Example 6 | Example 1 |
| Polyether | CHE-2801L | 79.8 | — | — | — | — | 84.3 | 89.8 |
| polyol | 10LD83EK | — | 76 | — | 83.8 | 79.1 | — | — |
| | KE-810L | — | — | 72.9 | — | — | — | — |
| Polymer | CHP-H45 | 5 | — | 10 | 6 | — | 5 | 5 |
| polyol | P40 | — | 10 | — | — | 7 | — | — |
| Polyether carbonate polyol I | | 10 | — | 8 | 5 | — | — | — |
| Polyether carbonate polyol II | | — | 6 | — | — | 7 | 5 | — |
| Chain | Ethylene | 3 | — | — | — | 4 | — | — |
| extender | glycol | | | | | | | |
| | Diethylene | — | 5 | — | 3 | — | 2.5 | 3 |
| | glycol | | | | | | | |
| | 1,4-butanediol | — | — | 6 | — | — | — | — |
| Surfactant | B8745 | — | — | — | 0.6 | — | — | — |
| | B8734 | 0.5 | — | — | — | 0.8 | — | — |
| | B8738 | — | — | 1.2 | — | — | 0.7 | — |
| | S6109 | — | 1.0 | — | — | — | — | 0.5 |
| Catalyst | DPA | 0.2 | 0.4 | 0.3. | 0.6 | — | 0.3 | 0.2 |
| | Z130 | 0.5 | — | 0.5 | — | 0.2 | — | 0.5 |
| | NE1050 | — | 0.6 | — | 0.2 | 0.2 | 0.5 | — |
| Water | | 0.4 | 1.0 | 0.6 | 0.8 | 0.5 | 0.7 | 0.4 |
| Color paste | | 0.6 | 0 | 0.5 | 0 | 1.2 | 1 | 0.6 |
| Modified | Wannat- | 35 | | | | 28 | | 35 |
| MDI | 100LL | | | | | | | |
| | Cosmonate LL | | 30 | | 38 | | | |
| | Suprasec2020 | | | 25 | | | 40 | |

| | | | | | | | |
|---|---|---|---|---|---|---|---|
| Curing time (min) | 3 | 2.5 | 2 | 2.8 | 2.5 | 2.2 | 3 |

TABLE 3
Performance test data of polyurethane sealing materials in Examples 1-6 and Comparative Example 1

| | Example | Example | Example | Example | Example | Example | Comparative |
|---|---|---|---|---|---|---|---|
| Testing items | 1 | 2 | 3 | 4 | 5 | 6 | Example 1 |
| Density (kg/m³) | 354 | 280 | 321 | 303 | 344 | 311 | 354 |
| Elongation at break (%, | 135 | 102 | 114 | 111 | 122 | 115 | 105 |
| Normal condition) | | | | | | | |
| Elongation at break (%) | 155 | 112 | 124 | 122 | 136 | 124 | 89 |
| 120° C., 168 h | | | | | | | |
| Elongation at break (%) | 161 | 108 | 112 | 126 | 138 | 111 | Powdering |
| 120° C., 500 h | | | | | | | |
| Tensile strength (Kpa) | 810 | 751 | 834 | 721 | 810 | 830 | 670 |
| (Normal condition) | | | | | | | |
| Tensile strength (Kpa) | 1011 | 921 | 999 | 923 | 1210 | 1079 | 431 |
| 120° C., 168 h | | | | | | | |
| Tensile strength (Kpa) | 1232 | 1024 | 1137 | 1009 | 1221 | 1126 | Powdering |
| 120° C., 500 h | | | | | | | |
| Permanent compression set | 8.2 | 10.2 | 9.3 | 9.1 | 8.4 | 9.2 | 11.5 |
| (%) (50%, 22 h, 70° C.) | | | | | | | |
| Tear strength (N/cm) | 9.2 | 8.4 | 8.7 | 9.0 | 8.1 | 9.3 | 7.6 |
| Tear strength (N/cm) | 15.8 | 14.7 | 14.5 | 13.9 | 13.5 | 15.6 | 3.5 |
| 120° C., 168 h | | | | | | | |
| Tear strength (N/cm) | 16.6 | 15.1 | 16.5 | 15.3 | 15.6 | 14.2 | Powdering |
| 120° C., 500 h | | | | | | | |

Based on the comparison between Examples 1-6 and Comparative Example 1 in Table 3, it can be seen that the polyurethane sealing materials prepared by adding the polyether carbonate polyol in the formulations have better elongation at break, tensile strength, and tear strength after aging than those under normal conditions, such that the prepared polyurethane sealing materials can be better used in life, especially under high-temperature conditions. In addition, the prepared polyurethane sealing materials have lower permanent compression set and can reach better technical effects.

The present disclosure adopts polyether polyol with a molecular weight of 6000 MW, which contains highly active EO groups, ensuring the post-curing of a sealing ring system of the polyurethane sealing material and improving production efficiency. The polyether carbonate polyol is also used. Although conventional polycarbonate polyols have low reactivity, and their ester bonds have high bond energy, which can impart high mechanical properties to the product. Nevertheless, existing polycarbonate polyols at room temperature have extremely high viscosity, the present disclosure adopts low-viscosity polyether carbonate polyol, which not only contains carbonate bonds but also exhibits polyether characteristics, and can maintain a low viscosity at room temperature, making it suitable for incorporating into the sealing ring system and meeting its processing requirements, such that mechanical properties of the product are greatly improved, and the product, combined with the polymer polyol, can maintain a high open porosity, as well as appropriate curing and initial hardness. Finally, low-functionality isocyanate and a proper ratio can make the entire system flexible and resilient.

### Example 7

A preparation method of the polyurethane sealing material, including the following steps:
(1) preparation of Component A: the following materials were weighed in parts by weight, 50 parts of polyether polyol (10LD83EK), 5 parts of polyether carbonate polyol I, 3 parts of a chain extender (ethylene glycol), 0.5 part of a surfactant (B8734), 0.7 part of a catalyst I (DPA), 0.3 part of a catalyst II (DMEA), 0.5 part of water, and 30 part of barium sulfate were added in sequence in a container A; and the foregoing raw materials were stirred evenly at a temperature of 20-25° C. to obtain Material I.
(2) Preparation of Component B: 25 parts of modified MDI (Wannat-100LL) was added into a container B, and stored at a temperature of 20-25° C. for later use, and Material II was obtained.
(3) Material I and Material II were pumped into Material Tank A and Material Tank B, respectively, and high-pressure circulation of Material Tank A and Material Tank B was started, respectively; a weight ratio of Material I to Material II was set to 100:25 on a high-pressure foaming machine, Material I and Material II were mixed and stirred in the high-pressure foaming machine at a high speed, and then rapidly injected into a pre-prepared closed mold, and a temperature of the closed mold was set at 50-65° C.; and after the injection was complete, the mold was closed and cured for 2.5 min, then the mold was opened to obtain the household polyurethane sealing material product.

### Examples 8-12 and Comparative Example 2

Examples 8-12 and Comparative Example 2 were performed according to the steps in Example 7, except that reaction raw materials and raw material ratios in forming formulations were different, as shown in Table 4; and performance test data of the prepared polyurethane sealing materials were shown in Table 5.

TABLE 4
Parts of each component by weight in formulations of polyurethane
sealing materials in Examples 7-12 and Comparative Example 2

| | | Example | Example | Example | Example | Example | Example | Comparative |
|---|---|---|---|---|---|---|---|---|
| Component name | | 7 | 8 | 9 | 10 | 11 | 12 | Example 2 |
| Polyether | CHE-2801L | — | 55.3 | — | — | 60.1 | — | — |
| polyol | 10LD83EK | 50 | — | — | 54.3 | — | — | 64.5 |
| | KE-810L | — | — | 55.6 | — | — | 57 | — |
| Polyether carbonate polyol I | | 5 | — | — | 6 | 5 | — | — |
| Polyether carbonate polyol II | | — | 8 | 10 | — | — | 7 | — |
| Chain | Ethylene glycol | 3 | — | 6 | — | — | — | — |
| extender | Diethylene glycol | — | 5 | — | — | 4 | 3 | 3 |
| | 1,4-butanediol | — | — | — | 2 | — | — | — |
| Surfactant | B8745 | — | 0.8 | — | — | — | 0.5 | — |
| | B8734 | 0.5 | — | — | — | 0.8 | — | 0.5 |
| | B8742 | — | — | 1 | — | — | — | — |
| | B8738 | — | — | — | 1.2 | — | — | — |
| Catalyst I | DPA | 0.7 | — | — | — | — | 0.8 | 0.7 |
| | Z130 | — | 0.8 | — | 0.8 | — | — | — |
| | NE1050 | — | — | 0.7 | — | 0.8 | — | — |
| Catalyst II | ZF10 | — | — | — | 0.2 | — | — | — |
| | DMEA | 0.3 | — | — | — | 0.2 | — | 0.3 |
| | A-1 | — | — | — | — | — | 0.1 | — |
| | NE300 | — | 0.1 | — | — | — | — | — |
| | LED103 | — | — | 0.2 | — | — | — | — |
| Solid filler | Calcium | — | 29 | — | — | 28 | — | — |
| | carbonate (g) | | | | | | | |
| | Barium sulfate (g) | 30 | — | — | 35 | — | 30 | 30 |
| | White carbon | — | — | 25 | — | — | — | — |
| | black (g) | | | | | | | |
| Water | | 0.5 | 0.4 | 0.6 | 0.2 | 0.3 | 0.9 | 0.5 |
| BA316 | | 0 | 0.5 | 0.8 | 0 | 0.4 | 0.2 | 0.5 |
| Modified | Wannat-100LL | 25 | — | — | — | — | 35 | 25 |
| MDI | Cosmonate LL | — | 35 | — | — | — | — | — |
| | Suprasec2020 | — | — | 30 | — | 25 | — | — |
| | Wannat-100LL | — | — | — | 20 | — | — | — |

| | | | | | | | |
|---|---|---|---|---|---|---|---|
| Curing time (min) | 2.4 | 2.8 | 2.1 | 1.9 | 3.0 | 2.7 | 2.5 |

TABLE 5
Performance test data of household polyurethane sealing
materials in Examples 7-12 and Comparative Example 2

| | Example | Example | Example | Example | Example | Example | Comparative |
|---|---|---|---|---|---|---|---|
| Testing items | 7 | 8 | 9 | 10 | 11 | 12 | Example 2 |
| Density (kg/m³) | 336 | 354 | 333 | 448 | 372 | 285 | 357 |
| Elongation at break | 115 | 128 | 111 | 143 | 135 | 95 | 111 |
| (%, Normal condition) | | | | | | | |
| Elongation at break | 102 | 105 | 98 | 106 | 112 | 83 | 92 |
| (%) 120° C., 168 h | | | | | | | |
| Elongation at break | 82 | 88 | 91 | 79 | 88 | 76 | Powdering |
| (%) 120° C., 500 h | | | | | | | |
| Tensile strength (Kpa) | 632 | 641 | 625 | 627 | 626 | 558 | 556 |
| (Normal condition) | | | | | | | |
| Tensile strength (Kpa) | 537 | 519 | 503 | 511 | 509 | 433 | 270 |
| 120° C., 168 h | | | | | | | |
| Tensile strength (Kpa) | 254 | 367 | 381 | 261 | 254 | 184 | Powdering |
| 120° C., 500 h | | | | | | | |
| Permanent compression set | 13.3 | 14.7 | 13.4 | 13.3 | 14.2 | 13.5 | 17.2 |
| (%) (50%, 22 h, 70° C.) | | | | | | | |
| Tear strength (N/cm) | 8.6 | 9.4 | 8.9 | 9.2 | 9.1 | 8.0 | 6.5 |
| Tear strength (N/cm) | 8.3 | 9.0 | 9.1 | 8.8 | 8.3 | 8.2 | 4.2 |
| 120° C., 168 h | | | | | | | |
| Tear strength (N/cm) | 4.0 | 5.4 | 5.2 | 4.2 | 3.7 | 3.0 | Powdering |
| 120° C., 500 h | | | | | | | |

Based on the comparison between Examples 7-12 and Comparative Example 2 in Table 5, it can be seen that the polyurethane sealing materials prepared by adding the polyether carbonate polyol in the formulations do not exhibit great degradation in terms of elongation at break, tensile strength, and tear strength after 168 h of aging, and can meet the use in daily household conditions. In addition, the prepared polyurethane sealing materials have lower permanent compression set and can reach better technical effects.

The specific embodiments are merely the explanation of, rather than limitations on, the present disclosure. After reading the specification, those skilled in the art may make modifications to the embodiments without any inventive contributions as needed, however, as long as these modifications fall within the scope of the claims of the present disclosure, they are protected by the patent law.

What is claimed is:

1. A polyurethane sealing material, wherein the material is composed of Component A and Component B, a ratio in parts by weight of the Component A to the Component B is 100:20-40, the Component A is composed of the following components in parts by weight: 70-90 parts of polyether polyol, 5-10 parts of polymer polyol, 5-10 parts of polyether carbonate polyol, 2-6 parts of a chain extender, 0.5-1.2 parts of a surfactant, 0.4-1 part of a catalyst, 0.2-1 part of a foaming agent, and 0-4 parts of a filler; the polyether polyol is a polyether polyol copolymerized with ethylene oxide and propylene oxide, and terminated with ethylene oxide, with at least one of glycerol or trimethylolpropane as an initiator, and the polyether polyol has a hydroxyl value of 25-30 mgKOH/g and a viscosity of 800-1500 mPa·s at 25° C.; the polymer polyol has a functionality of 3, a hydroxyl value of 19-23 mgKOH/g, and a solid content of 41-45%; the polyether carbonate polyol has a functionality of 2-3, a molecular weight of 2000-4000, and a mass percentage of CO₂ of 10-20%; the chain extender is selected from at least one of alcohol compounds or alcohol amine compounds with a functionality of 2; the catalyst is a tertiary amine catalyst; the surfactant is a polysiloxane-olefin oxide block copolymer; and Component B is modified MDI.

2. A polyurethane sealing material, wherein the material is composed of Component A and Component B, a ratio in parts by weight of the Component A to the Component B is 100:20-40, the Component A is composed of the following components in parts by weight: 50-70 parts of polyether polyol, 5-10 parts of polyether carbonate polyol; 2-6 parts of a chain extender, 0.5-1.2 parts of a surfactant, 0.7-1.5 parts of a catalyst I, 0.1-0.3 part of a catalyst II, 0.2-1 part of a foaming agent, 0-1 part of an anti-aging agent, and 10-40 parts of a solid filler; the polyether polyol has a functionality of 2-4 and a hydroxyl value of 25-30 mgKOH/g, the polyether carbonate polyol has a functionality of 3, a hydroxyl value of 19-23 mgKOH/g, and a solid content of 41-45%; the chain extender is selected from at least one of alcohol compounds or alcohol amine compounds with a functionality of 2; the catalyst I and the catalyst II are tertiary amine catalysts; the surfactant is a polysiloxane-olefin oxide block copolymer; and Component B is modified MDI.

3. The polyurethane sealing material according to claim 1, wherein the chain extender is selected from at least one of ethylene glycol, diethylene glycol or 1,4-butanediol.

4. The polyurethane sealing material according to claim 2, wherein the chain extender is selected from at least one of ethylene glycol, diethylene glycol or 1,4-butanediol.

5. The polyurethane sealing material according to claim 1, wherein the surfactant is selected from at least one of B8745, B8734, B8742, B8738, S6109, S6308, L-3627 or L-3628.

6. The polyurethane sealing material according to claim 2, wherein the surfactant is selected from at least one of B8745, B8734, B8742, B8738, S6109, S6308, L-3627 or L-3628.

7. The polyurethane sealing material according to claim 1, wherein the catalyst is selected from at least one of DPA, Z130, NE1050, 33LV or B8154; the foaming agent is water; and the filler is color paste.

8. The polyurethane sealing material according to claim 2, wherein the catalyst I is selected from at least one of DPA, Z130, NE1050, 33LV or B8154; the catalyst II is selected from at least one of ZF10, A-1, NE300, LED103 or DMEA; and the foaming agent is selected from water.

9. The polyurethane sealing material according to claim 2, wherein the anti-aging agent is selected from BA316, and the solid filler is selected from one or a mixture of white carbon black, calcium carbonate, fly ash, lignin, titanium dioxide, talc, and barium sulfate.

10. The polyurethane sealing material according to claim 1, wherein the modified MDI is selected from at least one of Wannat-100LL, Cosmonate LL, Lupranate81/MM103/218/219 or Suprasec2020.

11. The polyurethane sealing material according to claim 2, wherein the modified MDI is selected from at least one of Wannat-100LL, Cosmonate LL, Lupranate81/MM103/218/219 or Suprasec2020.

12. A preparation method of the polyurethane sealing material according to claim 1, comprising the following steps:
(1) preparation of the Component A: the following materials are weighed in parts by weight, 70-90 parts of the polyether polyol, 5-10 parts of the polymer polyol, 5-10 parts of the polyether carbonate polyol, 2-6 parts of the chain extender, 0.5-1.2 parts of the surfactant, 0.4-1 part of the catalyst, 0.4-1 part of the catalyst, 0.2-1 part of the foaming agent, 0-4 parts of the filler are added in sequence in a container A; and the materials are stirred evenly at a temperature of 20-25° C. to obtain Material I; or
preparation of the Component A: the following materials are weighed in parts by weight, 50-70 parts of the polyether polyol, 5-10 parts of the polyether carbonate polyol; 2-6 parts of the chain extender, 0.5-1.2 parts of the surfactant, 0.7-1.5 parts of the catalyst I, 0.1-0.3 part of the catalyst II, 0.2-1 part of the foaming agent, 0-1 part of the anti-aging agent, and 10-40 parts of the solid filler are added in sequence in a container A; and the materials are stirred evenly at a temperature of 20-25° C. to obtain Material I;
(2) preparation of the Component B: the modified MDI is added into a container B, and stored at a temperature of 20-25° C. for later use, and Material II is obtained;
(3) Material I and Material II are pumped into Material Tank A and Material Tank B, respectively, and high-pressure circulation of the Material Tank A and the Material Tank B is started, respectively; a weight ratio of the Material I to the Material II is set at 100:20-40 on a high-pressure foaming machine, the Material I and the Material II are mixed and stirred in the high-pressure foaming machine at a high speed, and then rapidly injected into a pre-prepared closed mold, and a temperature of the closed mold is set at 50-65° C.; and after the injection is complete, the mold is closed and cured for 2-3 min, then the mold is opened to obtain the polyurethane sealing material product.

13. An application of the polyurethane sealing material according to claim 1 in air filter sealing rings, wherein the air filter sealing rings comprise automobile air filter sealing rings and household air filter sealing rings.

14. An application of the polyurethane sealing material according to claim 2 in air filter sealing rings, wherein the air filter sealing rings comprise automobile air filter sealing rings and household air filter sealing rings.
